(19) United States
(12) Patent Application Publication
(10) Pub. No.: US 2009/0037325 A1
(43) Pub. Date: Feb. 5, 2009

(54) Offline and online affiliate sales network

(76) Inventors: Seth H. Sarelson, New York, NY (US); Jonathan A. Treiber, New York, NY (US)

Correspondence Address: HEDMAN & COSTIGAN P.C., 1185 AVENUE OF THE AMERICAS, NEW YORK, NY, 10036, US

(21) Appl. No.: 11/888,963

(22) Filed: Aug. 3, 2007

(51) Int. Cl. G06Q 40/00

(52) U.S. Cl. 705/39

(57) ABSTRACT

A method of marketing a merchant's goods and/or services including the steps of registering each of a merchant, a publisher, and a consumer's payment vehicle with a network, such that each time a publisher causes a consumer to use a registered payment vehicle to purchase goods and/or services from the merchant, the merchant pays a first fee to the network and the network pays a second fee to the publisher. The network may also keep a portion of the first fee for itself. The network or the publisher optionally sends a portion of the fee back to the consumer. The entire method can be practiced either on-line, off-line or via a combination of both on-line and off-line.

### FIELD OF THE INVENTION

The invention relates to the field of sales and marketing. More particularly, the invention relates to affiliate sales networks.

### BACKGROUND OF THE INVENTION

Traditional online affiliate sales/marketing networks (“ASN”) such as LINKSHARE®, COMMISSION JUNCTION®, PERFORMICS®, AZOOGLE®, and SHAREASALE® match merchants seeking pay-per-action marketing with internet publishers seeking to earn commissions by promoting a merchant's products and/or services. These ASNs eliminate the risk of ineffective marketing by only charging the merchant a fee when the publisher produces the desired result. The desired result may range from the sale of goods and/or services to registering a consumer for a subscription or service to any other action that the merchant would like a consumer to take. The publisher is paid only when a consumer completes the desired action with the merchant. In this document, the term “publisher(s)” includes, but is not limited to, rewards/loyalty programs, magazines, newspapers, television networks, radio stations, web portals, blogs, search engines, internet websites, intranet websites, email marketers, video games, and a variety of other content providers that communicate with consumers.

The ASN tracks each consumer's actions from the publisher's website or email to the marketer's website and identifies whether the consumer completed the desired action. The ASN then reports this information back to both the merchant and publisher. The ASN bills and collects one payment from each merchant in a given time frame (for example, monthly) and then disburses commissions to each publisher in a given time frame (for example, monthly).

For the merchant, the ASN provides pay-per-action marketing, thereby eliminating the risk that a particular marketing channel (in this case, a publisher) will not perform or will not perform as well as the merchant desires. If the marketing channel does not perform, the merchant pays nothing to the ASN or the publisher. For example, if the merchant has an agreement with the publisher to pay the publisher a 5% commission on every sale, and the publisher serves an ad which directly results in a sale for $100, the merchant pays the ASN $5 plus an affiliate network fee. The ASN keeps the affiliate network fee and delivers $5 to the publisher as payment for delivering a sale of $100 to the merchant.

The ASN allows the merchant to reach a very large number of publishers (and, therefore, a very large number of consumers) and select those publishers the merchant desires to use as a commission-based sales force (also known as an affiliate sales force) to promote the merchant's goods and/or services. The merchant may also choose to develop a direct relationship with the publisher.

For the publisher, the ASN provides a way to easily and efficiently monetize consumer traffic on the publisher's web pages or email campaigns. The ASN provides the publisher with a set of standardized tools to select, display, and track impressions, clicks, revenue, and other metrics from merchant advertisements.

The ASNs are essentially hubs that match merchants with publishers and charge a fee on each commission that a merchant pays to a publisher. Historically, the ASN model has been incredibly successful because it is essentially risk-free for the merchant. The ASN model eliminates the needs for merchants and publishers to develop and integrate technology, directly exchange payments, or maintain a direct relationship.

This model, however, does have its flaws in that it can only function in an online environment for e-commerce. There is, at present, no type of ASN that can accommodate both offline (e.g., brick & mortar stores) and online merchants and offline (e.g., print media such as newspapers) and online publishers. Offline merchants are defined in this document as merchant locations that are non-internet based. This includes merchants that provide at least one physical location at which a consumer can shop (e.g., a retail storefront) and merchants that do not (e.g., mail order and telephone order). A merchant can be both online and offline, but the term “offline merchant(s)” is directed to the segment of a merchant's business that is conducted at a non-internet based location, such as a store. Offline publishers are defined in this document as those that use non-internet based media to communicate with the consumer. This includes, but is not limited to, print media, radio, and television. Online publishers are defined in this document as those publishers that use the internet to communicate with the consumer. A publisher can be both online and offline, but the term “offline publisher(s)” is directed to the segment of the publisher's business that is conducted via non-internet based media.

In today's marketplace, there is no way for an offline merchant to engage an affiliate sales force with pay-per-sale marketing. Therefore, offline merchants are forced to engage in marketing efforts that have substantial up-front costs. Direct mail and other traditional media are not cost-effective, thus erecting a barrier that prevents smaller merchants with less capital from engaging in effective marketing through traditional channels. Traditional marketing efforts have burdened merchants with up-front costs regardless of the successes of such efforts. A merchant must pay for a television advertisement, direct mail campaign, or newspaper advertisement regardless of whether or not revenue is generated from that advertisement or campaign. When revenue is generated, the merchant is left guessing at the effectiveness of each marketing method unless some form of tracking method (e.g., promotional codes or coupons) is used. The up-front costs and lack of transparency as to efficacy are a major frustration to a merchant's ad buyer(s).

Many publishers that work with traditional ASNs are loyalty/rewards programs that exist by remarketing the commissions paid to them by merchants. Remarketing is defined in this document as a method of using the commission paid by merchants to provide a financial incentive (such as cash-back, points, or other reward) to consumers to shop with a particular merchant. These loyalty/rewards programs earn their commission (as described above), however, rather than keeping the entire commission, the loyalty/rewards program keeps only a portion and sets aside the remaining portion of the commission to remarket to the consumer as a moneymaking opportunity for the consumer.

The remarketing amount can range from 0%-100% of the publisher's commission. For example, Merchant A offers a 5% commission on every sale to each publisher. A loyalty/rewards program will keep, e.g., 1% of the commission and offer the consumer the remaining 4% as a cash-back rebate or other equivalent point value for shopping with the merchant. Loyalty/rewards programs offer many variations on this model, with specialized programs marketed using cash-back for everything from funding 529 college savings plans to community fundraising efforts to charitable donations. These programs include UPROMISE®, IGIVE.COM®, IBAKESALE®, FUNDRAISERREWARDS®, SCHOOLPOP®, MYPOINTS®, as well as a variety of others.

Because traditional ASNs exclude offline merchants, commission opportunities are limited for many publishers, specifically the aforementioned loyalty/rewards programs, which would earn significantly increased revenues from driving sales to offline merchants.

In addition to the loyalty/rewards programs that utilize traditional ASNs, several programs utilize registered payment card technology to deliver sales for offline merchants. These programs include REWARDS NETWORK^{SM} (formerly IDINESM), RAINBOW REWARDS^{SM}, and American Express' TAILORMADE^{SM}. Consumers can use any registered credit or debit card (with the exception of TAILORMADE^{SM}, which is only for AMERICAN EXPRESS® cards) at an enrolled merchant (either online or offline) to generate cash-back or points with these programs. This is very convenient for the consumer but can be unattractive for a merchant due to a problem known in the art as “double-dipping”.

Double-dipping is defined as when a merchant unintentionally pays a commission two or more times on one purchase. This can occur when a merchant participates in both a registered payment card program and a traditional ASN. If the consumer uses the card that has been registered for a program like TAILORMADE^{SM} and also shops through an online loyalty/rewards program that works with an ASN, such as IGIVE.COM®, the merchant must pay a commission to both TAILORMADE^{SM} and IGIVE.COM® when the consumer makes a purchase. This double-dipping cannot easily be stopped because the ASN transactions are tracked using unique links via the internet, whereas the registered payment card transactions are tracked using payment card data. That is, the single transaction is tracked by two different methods that are not reconciled with each other. This is extremely unattractive for the merchant, who would ideally manage one affiliate relationship and only pay one commission for each sale. Given the penetration of traditional ASNs, the end result of this double-dipping is that the merchant typically drops out of the registered payment card program.

For these reasons, it is desirable to provide an improved ASN that can be used by both offline and online merchants to engage in pay-per-sale marketing with both offline and online publishers.

### SUMMARY OF THE INVENTION

It is therefore an object of the present invention to create a single ASN that allows for offline and online merchants to engage in pay-per-sale marketing with both offline and online publishers.

It is another object of the present invention to provide a method whereby merchants can evaluate and choose individual publishers to act as an affiliate sales force, track results of sales efforts, and only pay a commission when sales efforts are successful.

It is a further object of the present invention to eliminate the merchant's risk of double-dipping by working with one ASN that uses one singular method (for example registered payment vehicle technology) to track all purchases in both online and offline environments.

It is an even further object of the present invention to provide publishers, especially loyalty/rewards programs publishers, with a new revenue opportunity to earn commissions for driving consumers to spend at offline merchants.

It is yet a further object of the present invention to provide consumers with the ability to register and use any payment vehicle (including, but not limited to, cash, checks, credit and debit cards, prepaid cards, check cards, chip cards, gift cards, RFID payment devices, cell phones, fingerprints, retinal scans, other trackable payment vehicles, etc.) to earn rewards for both online and offline shopping.

Accordingly, these objects and others not particularly set forth above are achieved by the method and system of the present invention which comprises the steps of registering publishers with a service, registering merchants with the same service, creating affiliate sales offers, matching publishers with merchants based on each merchant's approval of the publisher, soliciting and receiving registration of consumer payment vehicles by publishers, advertising by publishers to consumers on behalf of the merchants, spending by consumers at merchants using registered payment vehicles, tracking by the service (ASN) of each purchase via payments data, providing reporting to both merchants and publishers by the service, billing and receiving funds from the merchants by the service, and making payments to the publishers by the service.

The invention provides a solution to the problem that traditional ASNs have only been able to support online merchants. The invention is a new type of ASN that can provide pay-per-sale marketing for both offline merchants and online merchants. In today's marketplace, offline merchants cannot engage in pay-per-sale marketing that is risk-free. The invention eliminates both the uncertainty and financial risk associated with traditional marketing efforts that are not directly tied to revenue generated. The invention is an advantage over rewards programs such as REWARDS NETWORK^{SM} (formerly IDINE^{SM}), and RAINBOW REWARDS^{SM} that utilize registered payment card technology to deliver sales for offline merchants because these programs do not function as an ASN. They are independent programs and do not offer the ability for offline merchants to engage a plurality of publishers as a commission-based sales force.

The invention also provides a solution to the problem that traditional ASNs require publishers to frequently update links for various merchant offers to the consumer. Offers include free shipping, discounts, and other types of consumer promotions. With traditional ASNs, a publisher runs the risk that if there are any problems with the link, the publisher will not get credit or be able to track which consumer took the desired action with the merchant. This can cause serious problems for any loyalty/rewards programs that promise the consumer some type of compensation for the action.

The invention provides a solution to the problem that there is there is currently no method for loyalty/rewards programs that utilize traditional ASNs to generate revenues from purchases made with offline merchants. The invention provides a new revenue stream from offline merchants for loyalty/rewards programs that utilize traditional ASNs and remarket to consumers the commissions paid by merchants. The invention gives loyalty/rewards programs the opportunity to earn commissions from a previously unreachable segment of the retail marketplace by using payment tracking technology that can be applied to any merchant, regardless of physical or virtual location.

The invention utilizes payment tracking technology to provide a solution to the problem that merchants currently pay multiple commissions (i.e., suffer from double-dipping) on a single sale that is driven by a publisher on a traditional ASN with a card that is registered in a loyalty/rewards program in which the merchant participates. The invention of the present application can eliminate the risk of double-dipping by creating a centralized ASN that drives and precisely tracks sales for a multitude of merchants that are generated by a multitude of publishers.

The invention creates a new marketing channel that allows both offline and online merchants to engage both online and offline publishers as an affiliate sales force in an environment that is free of financial risk. This channel creates a new segment of the global economy by creating the opportunity for entrepreneurial publishers (e.g., loyalty/rewards programs) to generate revenue by driving consumers to spend at local offline merchants. These publishers and loyalty/rewards program can offer a variety of incentives to consumers for supporting local offline merchants. Unlike many local loyalty/rewards programs that use paper coupons or non-financial loyalty cards (e.g., STUDENT ADVANTAGE® and supermarket loyalty cards), the invention stimulates the local economy each time a consumer uses an existing payment vehicle.

The invention creates yet another new segment of the global economy by providing an alternative marketing channel for offline merchants. These merchants typically engage in marketing efforts with substantial up-front costs. Direct mail and other traditional media are not cost-effective thereby erecting a barrier that prevents smaller merchants with less capital from engaging in effective marketing through traditional channels. For the smallest merchants (e.g., those that do not have an advertising budget) the current model that requires payment regardless of success is prohibitive to engaging in any advertising activities. The new marketing channel created by this invention creates parity by allowing every merchant access to the same commission-based sales force.

The preferred method of the present invention provides a significant advantage to the merchant because the service works through the payments system, empowering merchants to participate in an ASN without having to run the transaction any differently or even notify the cashier.

Note that in this invention, the term “payment vehicle association” includes, but is not limited to, what is traditionally known as a credit card association, such as VISA® or MASTERCARD®.

Note that in this invention, the term “registered payment vehicle loyalty processor” includes, but is not limited to, what is traditionally known as a registered card loyalty processor, such as GOLDEN RETRIEVER SYSTEMS@.

A summary of the preferred steps of the method of marketing goods and services of a merchant is as follows:
a. registering a participating merchant's identification number with the ASN;
b. registering a publisher with the ASN;
c. registering a consumer's payment vehicle with the ASN in order to create a registered consumer;
d. creating a consumer account associated with a registered consumer, said account being able to include one or more registered payment vehicles;
e. delivering advertisements to said registered consumers;
f. accepting said registered payment vehicles at registered merchants for the purchase of goods and/or services;
g. scanning transactional data to match transactions from a registered merchant with a registered payment vehicle;
h. charging a registered merchant a marketing fee when a registered consumer payment vehicle has been used to purchase goods and/or services by said registered consumer;
i. paying a registered publisher a marketing commission when a registered consumer payment vehicle has been used to purchase goods and/or services from a registered merchant based on marketing from a registered publisher to said registered consumer.

Optionally, the invention can comprise a further step of creating a commission structure by a participating merchant for affiliate sales by a participating publisher. The step of structuring a commission scale between a registered merchant and a registered publisher can be performed by several different entities including, but not limited to, merchants, registered payment vehicle loyalty processors, marketers, ASNs, financial institutions, banks, payments processors, payment vehicle associations, affinity organizations, payment card issuers, media companies, and combinations thereof.

The term “merchant” includes, but is not limited to, offline merchants, online merchants, and merchants with both an online and offline presence.

The step of registering a merchant's identification number can be performed by several different entities including, but not limited to, registered payment vehicle loyalty processors, marketers, ASNs, financial institutions, banks, payments processors, payment vehicle associations, affinity organizations, payment card issuers, merchants, media companies, and combinations thereof.

The term “publisher” includes, but is not limited to, offline publishers, online publishers, and publishers with both an online and offline presence. A non-exclusive list of publishers includes magazines, newspapers, television networks, radio stations, web portals, blogs, search engines, internet websites, intranet websites, email marketers, video games, registered payment vehicle loyalty processors, marketers, ASNs, financial institutions, banks, payments processors, payment vehicle associations, affinity organizations, payment card issuers, merchants, media companies, and combinations thereof.

The step of registering a publisher can be performed by several different entities including, but not limited to, registered payment vehicle loyalty processors, marketers, ASNs, financial institutions, banks, payments processors, payment vehicle associations, affinity organizations, payment card issuers, merchants, media companies, and combinations thereof.

The step of registering a consumer's payment vehicle can also be performed by several different entities including, but not limited to, magazines, newspapers, television networks, radio stations, web portals, blogs, search engines, internet websites, intranet websites, email marketers, video games, registered payment vehicle loyalty processors, marketers, ASNs, financial institutions, banks, payments processors, payment vehicle associations, affinity organizations, payment card issuers, merchants, media companies and combinations thereof.

The payment vehicle can include, but is not limited to, cash, checks, credit cards, debit cards, prepaid cards, check cards, chip cards, gift cards, Radio Frequency Identification (RFID) payment devices, cell phones, fingerprints, retinal scans, other trackable payment vehicles and combinations thereof. When cash is used, it may be tracked by serial number, imbedded RFID tag, or any other method of tracking cash whether currently known or unknown.

The registered consumer can include, but is not limited to, individuals, groups, organizations, businesses, private entities, commercial entities, government entities and combinations thereof.

The step of creating a consumer account can be performed by several entities, including, but not limited to, magazines, newspapers, television networks, radio stations, web portals, blogs, search engines, internet websites, intranet websites, email marketers, video games, registered payment vehicle loyalty processors, marketers, ASNs, financial institutions, banks, payments processors, payment vehicle associations, affinity organizations, payment card issuers, merchants, media companies, and combinations thereof.

The advertisements can include, but are not limited to, mail, email, text messaging, interactive voice response, magazine, newspaper, direct mail ads, billboards, signs, television ads, radio ads, movie ads, web portals, blogs, search engines, internet website ads, intranet website ads, banner ads, popup ads, video games, podcasts, and combinations thereof.

The step of scanning transactional data to match transactions from registered merchants can be performed by several entities including, but not limited to registered payment vehicle loyalty processors, marketers, ASNs, financial institutions, banks, payments processors, payment vehicle associations, affinity organizations, payment card issuers, merchants, media companies, and combinations thereof.

The step of charging the registered merchant a marketing fee can be performed by several entities including, but not limited to, registered payment vehicle loyalty processors, marketers, ASNs, financial institutions, banks, payments processors, payment vehicle associations, affinity organizations, payment card issuers, merchants, media companies, and combinations thereof.

The step of paying a registered publisher a marketing commission can be performed by several entities including, but not limited to, registered payment vehicle loyalty processors, marketers, ASNs, financial institutions, banks, payments processors, payment vehicle associations, affinity organizations, payment card issuers, merchants, media companies, and combinations thereof.

It is envisioned that other modifications can be made to the invention. For example, a percentage of the registered publisher's marketing commission can be distributed to the registered consumer as a reward. The reward can be in several forms including, but not limited to, reward points, currency based rewards, cash back rewards, and combinations thereof. The reward could be credited to the consumer in numerous ways including, but not limited to, crediting the reward directly to the registered consumer's registered payment vehicle.

It is preferred that a registered merchant is only charged one marketing fee per purchase of goods and/or services by a registered consumer payment vehicle, however it is within the scope of the invention that a merchant can be charged more than once per each purchase. Regardless of whether the merchant is charged one or more fees, the commission that the merchant pays may be paid to one publisher or divided among more than one publisher, however, it is preferred that the commission be directed to only one publisher.

The method of the present invention differs from traditional advertising in that it is a pay-per-sale marketing network that is financially risk-free for merchants of every size, regardless of whether they follow an offline or online business model, or a combination thereof. Traditional advertising methods are much riskier for merchants and typically require a significant upfront cost.

The method of the present invention is an improvement over registered card loyalty/rewards programs that are unique to one credit card because the invention enables a consumer to use any payment vehicle that he or she chooses. Programs like TAILORMADE^{SM} are inferior because the user can only use the AMERICAN EXPRESS® card registered under TAILORMADE^{SM}. The invention of the present application drives more sales to the merchant and more rewards for the consumer because the consumer can use any payment vehicle.

The method of the present invention is an advantage over rewards programs such as REWARDS NETWORK^{SM} (formerly IDINE^{SM}), and RAINBOW REWARDS^{SM} that utilize registered payment card technology with any credit or debit card to deliver sales for offline merchants because these programs do not function as an ASN. They are independent programs and do not offer the ability for offline merchants to engage a plurality of publishers as a commission-based sales force.

In accordance with the principles of the preferred method of this invention, the merchant does not have to take any proactive steps to participate other than registering and creating a commission structure for the publishers. There is no need to train cashiers or to purchase additional software or hardware. If the merchant can accept the payment vehicle that the consumer wishes to use for that specific purchase, the merchant can utilize this invention.

The principles of the preferred method of the present invention are effective for promoting the goods and/or services of both offline and online merchants. Up-front costs associated with direct-mail, mass-media advertising, or other methods directed at customer acquisition and retention can be eliminated, resulting in a much more economical model that ties advertising costs to actual merchant revenues. The invention eliminates the financial risks associated with traditional advertising and provides a clear advantage with a new type of marketing network available to merchants and publishers of every size.

### BRIEF DESCRIPTION OF THE DRAWINGS

The attached drawings are intended to better illustrate the present invention without limiting it in any manner whatsoever.

FIG. 1 is a schematic diagram illustrating a preferred embodiment of parties interacting in accordance with the principles of this invention.

FIG. 2 is a schematic diagram illustrating a preferred embodiment of the flow of funds involved in parties interacting in accordance with the principles of this invention.

### DETAILED DESCRIPTION OF THE PRESENT INVENTION

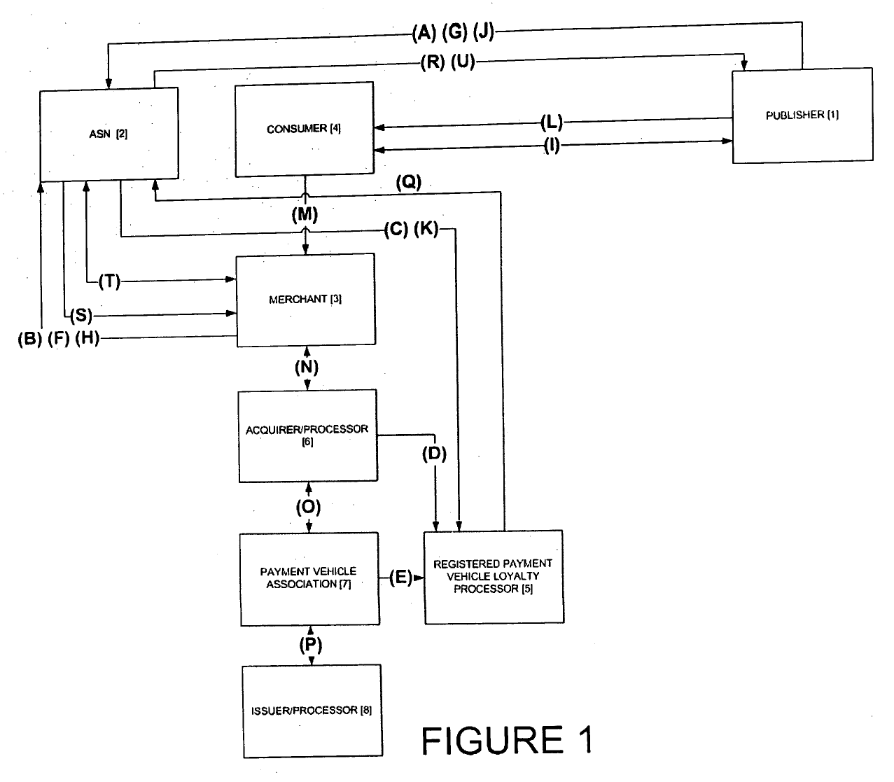

The following description is presented to describe the preferred embodiments of the present invention without limiting the scope of the appended claims. In FIG. 1, for the sake of clarity, letters are used to designate steps and numbers are used to designate entities. In some cases, multiple steps are shown along a single path in order to clarify the diagram (e.g., steps designated as A, G, and J are all shown along the same path). This is not to be construed as being the same step designated in different ways. Rather, it is to be construed as different steps.

As best shown in FIG. 1, a publisher (1) registers (A) with the ASN (2), providing information about the type of publication, industry focus, consumer traffic/reach, contact information, legal information, payment information, and/or any other relevant information that is useful to a merchant who might consider working with the publisher. A merchant (3) registers (B) with the ASN (2), providing information about the merchant's industry, consumer focus, necessary banking information, a merchant's identification number used for payments processing, and/or any other information that might be relevant. The merchant (3) also creates terms and conditions for the publishers, and gives consent to the ASN (2) for the registered payment vehicle loyalty processor (5) to legally obtain the merchant's transactional information. The ASN (2) then transmits (C) the merchant's identification number used for payments processing and consent to the registered payment vehicle loyalty processor (5) in order to legally obtain the merchant's transactional information. The registered payment vehicle loyalty processor (5) then begins to track payments information from the merchant's acquirer or Point-Of-Sale Processor (6) or the payment vehicle association (7) as necessary (D and E, respectively).

The merchant (3) creates a commission structure (F) with the ASN (2) for the publishers (1). The publisher (1) applies (G) with the ASN (2) to join a merchant's (3) affiliate sales force. The merchant (3) approves or declines (H) through the ASN (2) to work with the publishers (1) that have applied (G) to join the merchant's (3) affiliate sales force. If and when approved, the publisher (1) solicits and receives registration of payment vehicles (I) by consumers (4). The publisher (1) then transmits (J) this information back to the ASN (2). The ASN (2) then transmits (K) this information to the registered payment vehicle loyalty processor (5), which stores this information in a database that will be used later to match transactions between registered merchants (3) and registered payment vehicles belonging to consumers (4).

The publisher (1) then advertises (L) to consumers (4) to entice the consumers (4) to use registered payment vehicles at participating merchants (3) by shopping (M) with a participating merchant (3). The transaction is processed as normal between the merchant (3), acquirer/processor (6), payment vehicle association (7), and issuer/processor (8) (N, O, and P, respectively). A significant advantage of this invention is that the publisher (1) can use traditional media, such as a tangible newspaper, to generate commissions from driving sales at both online and offline merchants.

After the transaction has been processed as normal, the registered payment vehicle loyalty processor (5) receives payment information from the merchant's acquirer or Point-of-Sale Processor (6) or payment vehicle association (7) (D and E, respectively). The registered payment vehicle loyalty processor (5) then matches this information against its database of registered consumer (4) payment vehicles supplied by the ASN (2) (K). If the transaction qualifies (i.e., a consumer (4) used a registered payment vehicle to make a purchase (M) with a registered merchant (3)), the transaction is aggregated into a file with other qualified transactions provided (Q) by the registered card loyalty processor (5) to the ASN (2).

The ASN (2) provides reporting to the publisher (1) (R) and the merchant (3) (S). The ASN (2) bills and receives (T) funds from the merchant (3). Once funds have been received by the ASN (2), the ASN (2) disburses funds (U) to the publisher (1) while preferably keeping a portion for itself. It is envisioned that the registered payment vehicle loyalty processor (5) may also function as the ASN (2) or vice versa.

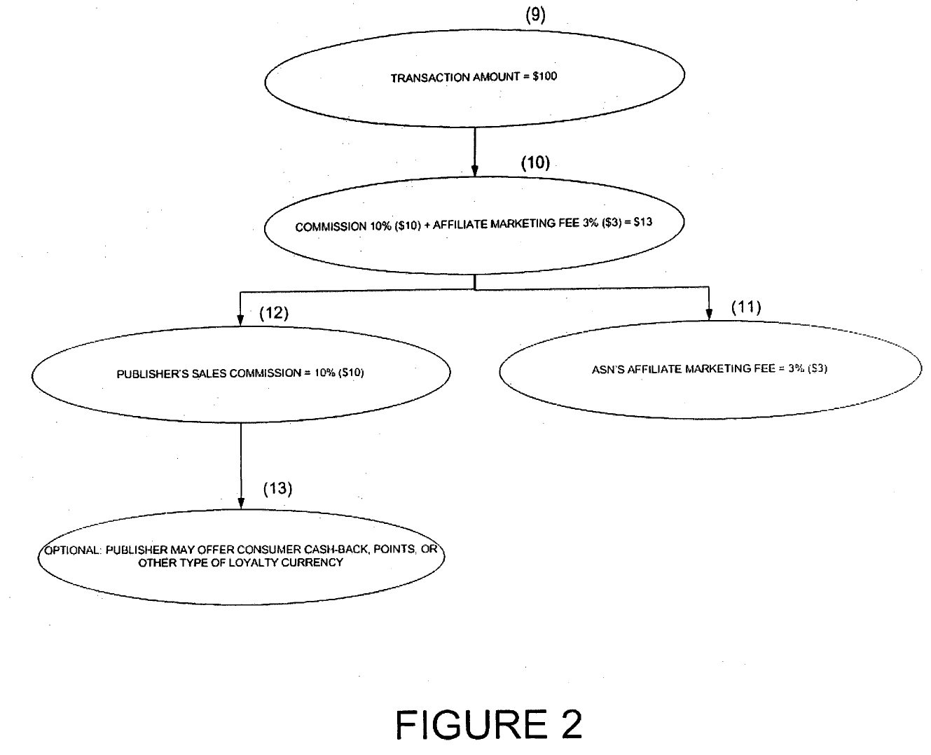

As best shown in FIG. 2, a given transaction is initiated (9) between a registered cardholder and a registered merchant in the ASN. For the purpose of this example, the transaction amount is $100 and the merchant is offering the publisher a 10% commission on sales the publisher creates for the merchant. The ASN collects (10) the value of the commission ($10), plus an additional affiliate marketing fee (here, e.g., $3). The ASN retains (11) the affiliate marketing fee ($3) and disburses (12) the sales commission ($10) to the publisher that directed the consumer to the merchant. Optionally, the publisher may offer (13) the consumer cash-back, points, or some other type of loyalty currency. This flow of funds provides a clear advantage over the up-front funds that each merchant would have spent on other media that does not tie marketing costs to actual merchant revenues.

Variations, modifications and changes to the preferred methods described above will be apparent to those skilled in the art. All such variations, modifications and changes are intended to fall within the spirit and scope of the present invention, limited solely by the appended claims.

1. A method of marketing a merchant's goods and/or services comprising the steps of:
a. registering a merchant's identification number to create a registered merchant;
b. registering a publisher to create a registered publisher;
c. registering a consumer by registering one or more payment vehicles of said consumer;
d. creating a consumer account associated with said registered consumer, said consumer account able to contain one or more registered payment vehicles;
e. delivering advertisements to said registered consumers via said registered publishers;
f. accepting said registered payment vehicles for the purchase of a registered merchant's goods and/or services;
g. scanning transactional data to match transactions from a registered merchant with a registered payment vehicle;
h. charging a registered merchant a marketing fee based upon said purchase of said registered merchant's goods and/or services by said registered consumer payment vehicle;
i. paying said registered publisher a marketing commission when said registered consumer purchases said registered merchant's goods and/or services based on advertising by said registered publisher.

2. The method of claim 1 wherein said merchant is selected from the group consisting of an offline merchant, an online merchant, and a merchant with both an online and offline presence.

3. The method of claim 1 wherein the step of registering a merchant's identification number is performed by one or more entities selected from the group consisting of a registered payment vehicle loyalty processor, a marketer, an ASN, a financial institution, a bank, a payments processor, a payment vehicle association, an affinity organization, a payment card issuer, a merchant, a media company, and combinations thereof.

4. The method of claim 1 wherein said publisher is selected from the group consisting of an offline publisher, an online publisher, and a publisher with both an online and offline presence.

5. The method of claim 1 wherein the step of registering said publisher is performed by one or more entities selected from the group consisting of a registered payment vehicle loyalty processor, a marketer, an ASN, a financial institution, a bank, a payments processor, a payment vehicle association, an affinity organization, a payment card issuer, a merchant, a media company, and combinations thereof.

6. The method of claim 1 wherein said registered publisher is selected from the group consisting of rewards/loyalty programs, magazines, newspapers, television networks, radio stations, web portals, blogs, search engines, internet websites, intranet websites, email marketers, video games, registered payment vehicle loyalty processors, marketers, ASNs, financial institutions, banks, payments processors, payment vehicle associations, affinity organizations, payment card issuers, merchants, media companies, and combinations thereof.

7. The method of claim 1 further comprising the step of structuring a commission scale between a registered merchant and a registered publisher.

8. The method of claim 7 wherein the step of structuring a commission scale between a registered merchant and a registered publisher is performed by one or more entities selected from the group consisting of the merchant, a registered payment vehicle loyalty processor, a marketer, an ASN, a financial institution, a bank, a payments processor, a payment vehicle association, an affinity organization, a payment card issuer, a media company, and combinations thereof.

9. The method of claim 1 wherein the step of registering said payment vehicle of said registered consumer is performed by one or more entities selected from the group consisting of magazines, newspapers, television networks, radio stations, web portals, blogs, search engines, internet websites, intranet websites, email marketers, video games, registered payment vehicle loyalty processors, marketers, ASNs, financial institutions, banks, payment processors, payment vehicle associations, affinity organizations, payment card issuers, merchants, media companies and combinations thereof.

10. The method of claim 1 wherein said payment vehicle is one or more selected from the group consisting of cash, a check, credit card, debit card, prepaid card, check card, chip card, gift card, Radio Frequency Identification (RFID) payment device, cell phone, fingerprint, retinal scan, other trackable payment vehicles and combinations thereof.

11. The method of claim 1 wherein said registered consumer is selected from the group consisting of an individual, a group, an organization, a business, a private entity, a commercial entity, a government entity and combinations thereof.

12. The method of claim 1 wherein the step of creating a consumer account is performed by one or more entities selected from the group consisting of magazines, newspapers, television networks, radio stations, web portals, blogs, search engines, internet websites, intranet websites, email marketers, video games, registered payment vehicle loyalty processors, marketers, ASNs, financial institutions, banks, payment processors, payment vehicle associations, affinity organizations, payment card issuers, merchants, media companies and combinations thereof.

13. The method of claim 1 wherein said advertisements are selected from the group consisting of mail, email, text messages, interactive voice responses, magazines, newspapers, direct mail ads, billboards, signs, movie ads, television ads, radio ads, web portals, blogs, search engines, internet website ads, banner ads, popup ads, intranet websites, video games, podcasts, and combinations thereof.

14. The method of claim 1 wherein the step of scanning transactional data to match transactions from said registered merchant is performed by one or more entities selected from the group consisting of registered payment vehicle loyalty processors, marketers, ASNs, financial institutions, banks, payment processors, payment vehicle associations, affinity organizations, payment card issuers, merchants, media companies, and combinations thereof.

15. The method of claim 1 wherein the step of charging said registered merchant a marketing fee is performed by one or more entities selected from the group consisting of registered payment vehicle loyalty processors, marketers, ASNs, financial institutions, banks, payment processors, payment vehicle associations, affinity organizations, payment card issuers, merchants, media companies, and combinations thereof.

16. The method of claim 1 wherein the step of paying said registered publisher a marketing commission is performed by one or more entities selected from the group consisting of registered payment vehicle loyalty processors, marketers, ASNs, financial institutions, banks, payment processors, payment vehicle associations, affinity organizations, payment card issuers, merchants, media companies, and combinations thereof.

17. The method of claim 1 wherein a percentage between 0%-100% of said registered publisher's marketing commission is distributed to said registered consumer as a reward.

18. The method of claim 17 wherein said reward is in the form of one or more selected from the group consisting of reward points, currency based reward, cash back reward, and combinations thereof.

19. The method of claim 17 wherein said reward is credited directly to said registered consumer's registered payment vehicle.

20. The method of claim 1 wherein a registered merchant is charged one marketing fee per purchase of said registered merchant's goods and/or services by said registered consumer payment vehicle.

21. The method of claim 20 wherein said marketing commission is paid to a plurality of publishers.

22. The method of claim 18 wherein said reward is credited directly to said registered consumer's registered payment vehicle.
